(19) United States
(12) Patent Application Publication
(10) Pub. No.: US 2020/0400700 A1
(43) Pub. Date: Dec. 24, 2020

(54) BIOCHEMICAL ANALYZER

(71) Applicant: DYNAMIKER BIOTECHNOLOGY (TIANJIN) CO., LTD, TIANJIN (CN)

(72) Inventors: Baoxue WANG, TIANJIN (CN); Zhenzhen DING, TIANJIN (CN); Miao MIAO, TIANJIN (CN); Zeqi ZHOU, TIANJIN (CN); Yan SU, TIANJIN (CN)

(73) Assignee: DYNAMIKER BIOTECHNOLOGY (TIANJIN) CO., LTD

(21) Appl. No.: 16/886,663

(22) Filed: May 28, 2020

Related U.S. Application Data
(63) Continuation of application No. PCT/CN2020/086462, filed on Apr. 23, 2020.

(30) Foreign Application Priority Data
Jun. 19, 2019 (CN) 201910533271.6

(51) Int. Cl. G01N 35/02; G01N 35/10; G01N 35/04; G01N 35/00

(52) U.S. Cl. CPC G01N 35/025; G01N 35/1002; G01N 2035/0496; G01N 35/00029; G01N 2035/046; G01N 35/04

(57) ABSTRACT

Provided is a biochemical analyzer, which includes a housing, a sample feeding mechanism, a rotating mechanism, a pipetting mechanism, analyzing mechanisms, a sample discharging mechanism and a sample discharging box, wherein a sample feeding port and a sample discharging port are formed in the housing; the sample feeding mechanism is arranged in the housing and capable of introducing detection cards containing samples and reagents into the housing from the sample feeding port; the rotating mechanism is capable of clamping a plurality of detection cards and driving the detection cards to rotate; the sample feeding mechanism is capable of clamping the detection cards on the rotating mechanism; the pipetting mechanism is capable of mixing the samples with the reagents on the detection cards; the analyzing mechanisms are capable of analyzing the samples through detection rays; the sample discharging mechanism is used for removing the detection cards from the rotating mechanism.

### CROSS-REFERENCE TO RELATED APPLICATIONS

This application is a continuation of International Patent Application No. PCT/CN2020/086462 with a filing date of Apr. 23, 2020, designating the United States, now pending, and further claims priority to Chinese Patent Application No. 201910533271.6 with a filing date of Jun. 19, 2019. The content of the aforementioned applications, including any intervening amendments thereto, are incorporated herein by reference.

### TECHNICAL FIELD

The present invention relates to the technical field of medical equipment, and particularly relates to a biochemical analyzer.

### BACKGROUND OF THE PRESENT INVENTION

Invasive fungal disease (IFD), also known as invasive fungal infection, refers to pathological changes and pathophysiological processes that fungi invade human tissues and blood and grow and reproduce in the human tissues and blood to cause tissue injury, organ dysfunction and inflammatory response. Common IFD comprises invasive candidiasis, aspergillosis, cryptococcosis, talaromyces marneffei, histoplasmosis of the capsule and the like. At present, identification and diagnosis methods for pathogenic fungi mainly comprise pathological biopsy or direct microscopy of clinical specimens, pathogen isolation and culture identification. In addition, operations such as sampling of trace samples, filling of precisely quantitative reagents and use of serial pipetting devices often need to be completed in the clinical diagnosis fields such as enzyme-linked immunosorbent assay (ELISA), chemiluminescent immunoassay (CLIA) and biochemical and turbidimetric assays, laboratories and food safety monitoring fields, and all require special laboratories and a large number of corresponding laboratory instruments, thereby causing complicated and inefficient operation processes and wasting the manpower and material resources.

### SUMMARY OF PRESENT INVENTION

A purpose of the present invention is to provide a biochemical analyzer capable of simply and efficiently inspecting and analyzing samples.

To achieve the purpose above, the following technical solution is adopted in the present invention.

A biochemical analyzer comprises:

a housing, in which a sample feeding port and a sample discharging port are formed;

a sample feeding mechanism, which is arranged in the housing and capable of introducing detection cards containing samples and reagents into the housing from the sample feeding port;

a rotating mechanism, which is arranged in the housing and capable of clamping a plurality of detection cards and driving the detection cards to rotate, wherein the sample feeding mechanism can clamp the detection cards on the rotating mechanism;

a pipetting mechanism, which is arranged in the housing, located above the rotating mechanism and capable of mixing the samples with reagents on the detection cards;

analyzing mechanisms, which are arranged in the housing and capable of analyzing the samples through detection rays;

a sample discharging mechanism, which is arranged in the housing and used for removing the detection cards from the rotating mechanism; and

a sample discharging box, which is slidably arranged at the sample discharging port and used for containing the detection cards after completing detection, wherein the sample discharging mechanism is capable of introducing the detection cards into the sample discharging box.

Preferably, the sample feeding mechanism comprises:

a sample feeding slide rail, which is arranged in the housing;

a sample feeding support base, which is slidably arranged on the sample feeding slide rail and on which the detection cards can be placed; and

a sample feeding driving device, which is arranged in the housing and capable of driving the sample feeding support base to slide along the sample feeding slide rail.

Preferably, the sample feeding mechanism further comprises a sample feeding detection device, which is arranged in the housing, located at one side of the sample feeding slide rail and is used for detecting whether the detection cards are placed on the sample feeding support base.

Preferably, the rotating mechanism comprises:

a rotating disk, which is rotatably arranged in the housing, wherein a plurality of clamping positions are uniformly distributed in a circumferential direction of the rotating disk, and one detection card can be clamped at each clamping position; and

a rotation driving device, which is arranged in the housing and capable of driving the rotating disk to rotate.

Preferably, clamping slots are formed in the clamping positions; clamping protrusions are arranged on the detection cards; the clamping protrusions can be clamped into the clamping slots while being pushed by the sample feeding mechanism; and the sample feeding mechanism cannot drive the clamping protrusions to release from the clamping slots.

Preferably, the pipetting mechanism comprises:

a pipetting fix base, which is arranged in the housing;

a pipetting slide base, which is slidably arranged on the pipetting fix base, wherein a sliding direction of the pipetting slide base is perpendicular to a rotating axial direction of the rotating mechanism;

a pipetting head, which is slidably arranged on the pipetting slide base and used for transferring reagents on the detection cards, wherein the sliding direction of the pipetting head is parallel to the rotating axial direction of the rotating mechanism;

a first pipetting drive device, which is arranged on the pipetting fix base and capable of driving the pipetting slide base to slide; and

a second pipetting drive device, which is arranged on the pipetting slide base and capable of driving the pipetting head to slide.

Preferably, the pipetting mechanism further comprises a pipetting support base, which is arranged in the housing and used for supporting the rotating mechanism at a pipetting position.

Preferably, the sample discharging mechanism comprises:

a sample discharging slide rail, which is arranged in the housing;

a sample discharging support base, which is slidably arranged on the sample discharging slide rail;

a sample discharging drive device, which is arranged in the housing, capable of driving the sample discharging support base to slide along the sample discharging slide rail and capable of removing the detection cards from the rotating mechanism and pushing the detection cards into the sample discharging box when the sample discharging support base slides.

Preferably, the sample discharging box comprises:

a box body, which is used for containing the detection cards after completing detection, slidably arranged at the sample discharging port and provided with an introducing port, wherein the sample discharging mechanism is capable of introducing the detection cards into the box body through the introducing port;

a pushing device, which is arranged in the housing and used for pushing the detection cards in the box body to move towards a detection end of the box body; and

a sample discharging detection device, which is arranged in the housing and can be triggered when the detection cards in the box body abut against the detection end.

Preferably, a sealing door is rotationally arranged at the sample feeding port, wherein the sample feeding mechanism can push the sealing door to open when feeding the samples, and the sealing door can seal the sample feeding port after finishing feeding the samples.

The present invention has the beneficial effects that:

The sample feeding mechanism, the rotating mechanism, the pipetting mechanism, the analyzing mechanisms and the sample discharging mechanism are arranged in a matching manner to inspect and analyze the plurality of samples automatically, simply and efficiently, thereby saving manpower and material resources, and making inspection processes safer and inspection results more reliable.

### DESCRIPTION OF THE DRAWINGS

FIG. 1 is a structural schematic diagram of a biochemical analyzer according to an embodiment of the present invention;

FIG. 2 is a structural schematic diagram of some parts of a biochemical analyzer according to an embodiment of the present invention;

FIG. 3 is a structural schematic diagram of a sample feeding mechanism according to an embodiment of the present invention;

FIG. 4 is a structural schematic diagram of a rotating mechanism according to an embodiment of the present invention;

FIG. 5 is a structural schematic diagram of a pipetting mechanism according to an embodiment of the present invention;

FIG. 6 is a structural schematic diagram of an analyzing mechanism according to an embodiment of the present invention;

FIG. 7 is a structural schematic diagram of a sample discharging mechanism according to an embodiment of the present invention;

FIG. 8 is a structural schematic diagram of one orientation of a sample discharging box according to an embodiment of the present invention; and

FIG. 9 is a structural schematic diagram of another orientation of the sample discharging box according to an embodiment of the present invention.

In the figures:

1. housing; 11. sealing door, 12. analysis display screen; 13. acrylic perspective plate;

2. sample feeding mechanism; 21. sample feeding slide rail; 22. sample feeding support base; 23. sample feeding drive device; 24. sample feeding detection device;

3. rotating mechanism; 31. rotating disk; 311. clamping slot; 32. rotating drive device;

4. pipetting mechanism; 41. pipetting fix base; 42. pipetting slide base; 43. pipetting head; 44. first pipetting drive device; 45. second pipetting drive device; 46. pipetting support base;

5. analyzing mechanism;

6. sample discharging mechanism; 61. sample discharging slide rail; 62. sample discharging support base; 63. sample discharging drive device;

7. sample discharging box; 71. box body; 711. introducing port; 72. pushing device; 73. sample discharging detection device.

### DETAILED DESCRIPTION OF PREFERRED EMBODIMENTS

Embodiments of the present invention will be described below in detail. Examples of the embodiments are shown in drawings, wherein same or similar reference signs refer to same or similar elements or elements having same or similar functions from beginning to end. Embodiments described below by reference to the drawings are exemplary embodiments, and are used for explaining the present invention, and shall not be understood as a limitation to the present invention.

In the description of the present invention, unless otherwise specifically regulated and defined, terms such as “connected”, “connecting” and “fixation” shall be understood in broad sense, and for example, may refer to fixed connection or detachable connection, may refer to mechanical connection or electrical connection, may refer to direct connection or indirect connection through an intermediate medium, and may refer to inner communication of two elements or interaction relationship of two elements. For those ordinary skilled in the art, the specific meanings of the above terms in the present invention may be understood according to concrete conditions.

In the description of the present invention, unless otherwise clearly specified and defined, a first feature is “above” or “below” a second feature comprises that the first feature and the second feature come into direct contact or the first feature and the second feature come into contact through additional features thereof instead of direct contact. Moreover, the first feature is “on”, “above” and “over” the second feature comprises that the first feature is directly above or slightly above the second feature, or just indicates that the horizontal height of the first feature is higher than that of the second feature. The first feature is “under”, “below” and “beneath” the second feature comprises that the first feature is directly below or slightly below the second feature, or just indicates that the horizontal height of the first feature is lower than that of the second feature.

A technical solution of the present invention will be further described with reference to the accompanying drawings and embodiments below.

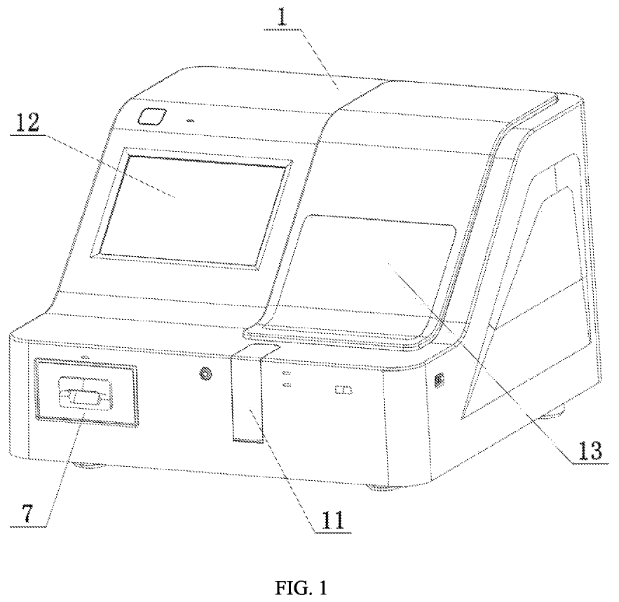

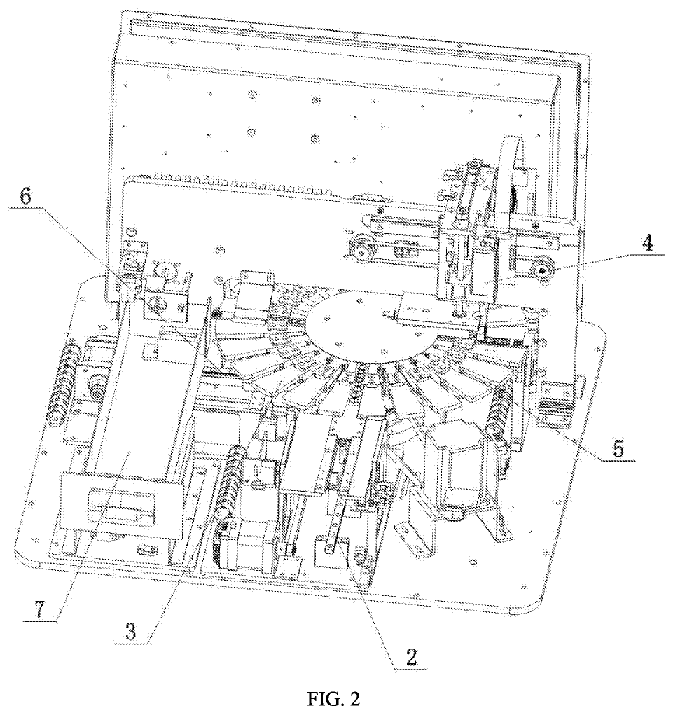

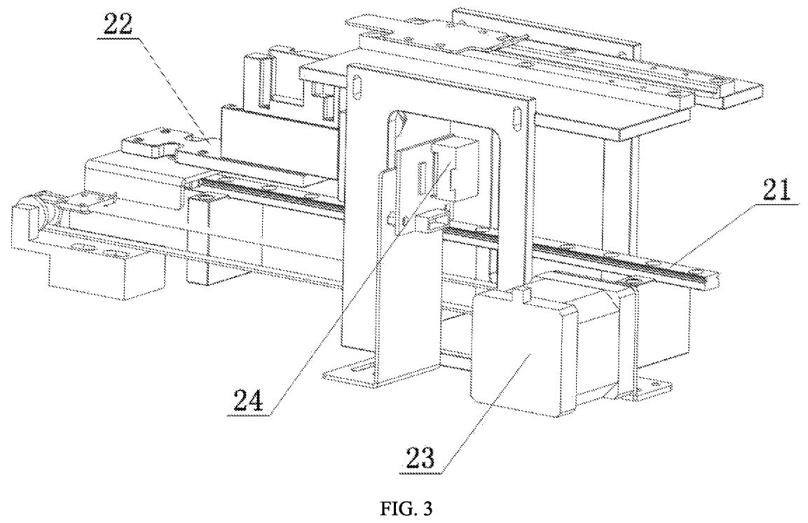

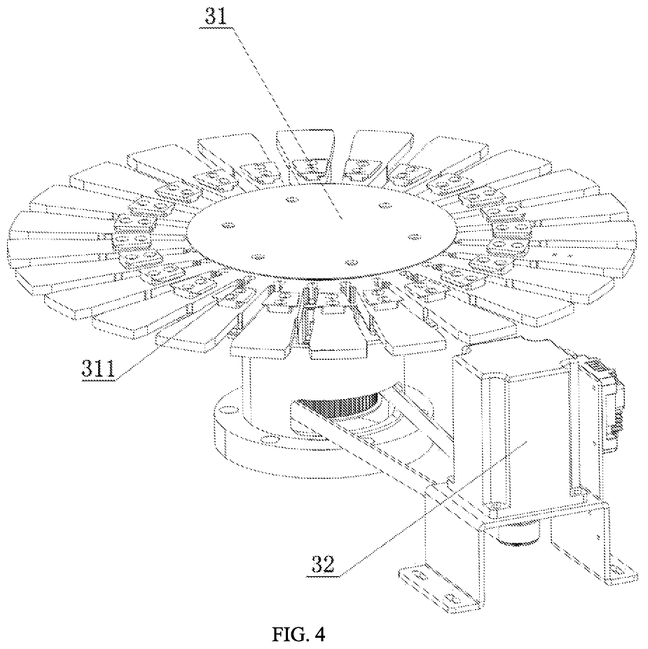

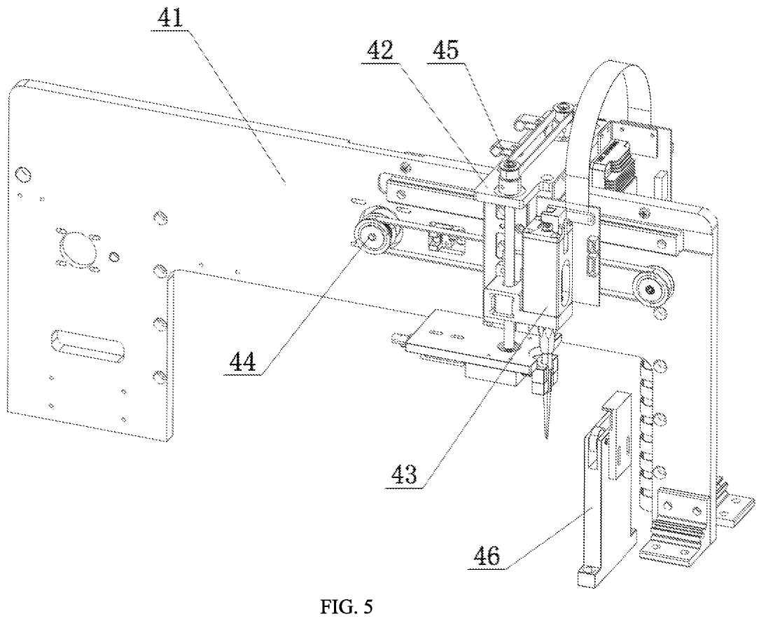

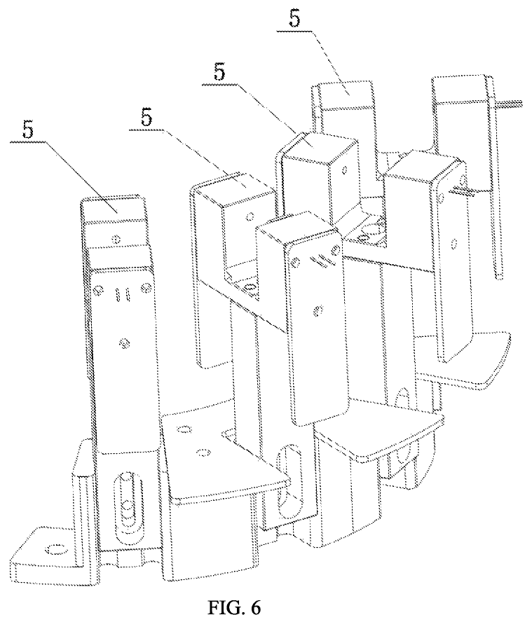

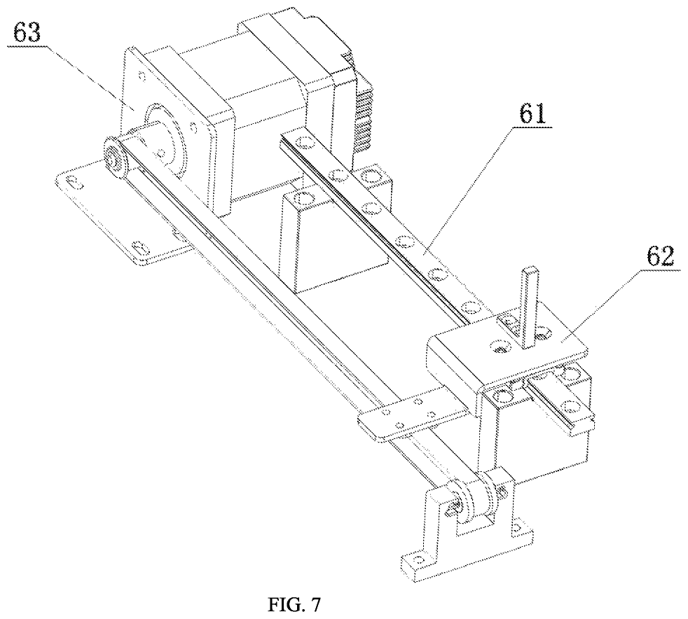

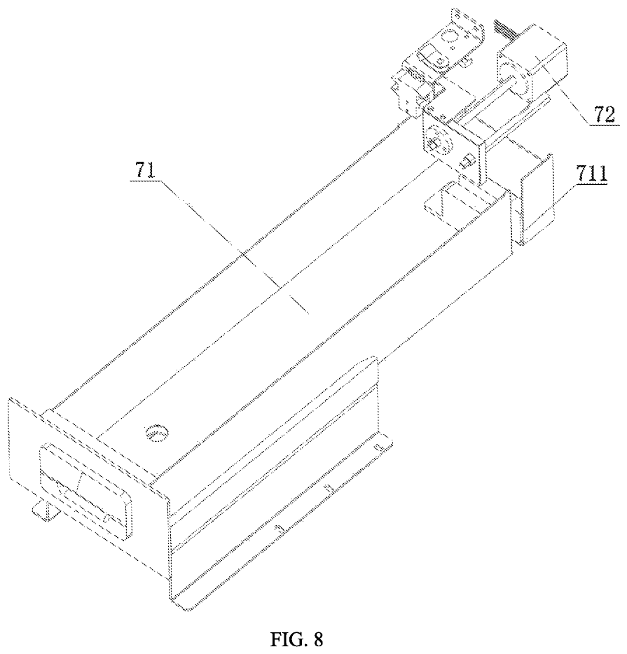

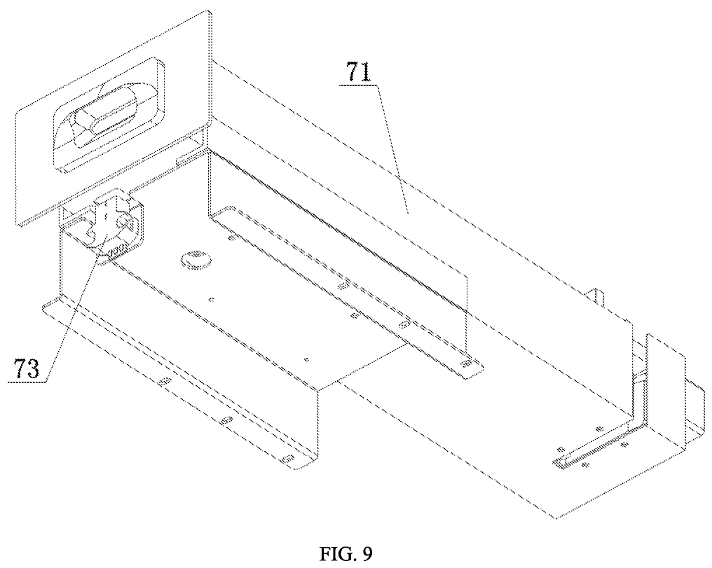

As shown in FIGS. 1-9, the present invention provides a biochemical analyzer, which comprises a housing 1, a sample feeding mechanism 2, a rotating mechanism 3, a pipetting mechanism 4, analyzing mechanisms 5, a sample discharging mechanism 6 and a sample discharging box 7, wherein a sample feeding port and a sample discharging port are formed in the housing 1; the sample feeding mechanism 2 is arranged in the housing 1 and capable of introducing detection cards containing samples and reagents into the housing 1 from the sample feeding port; the rotating mechanism 3 is arranged in the housing 1 and capable of clamping a plurality of detection cards and driving the detection cards to rotate; the sample feeding mechanism 2 is capable of clamping the detection cards on the rotating mechanism 3; the pipetting mechanism 4 is arranged in the housing 1, located above the rotating mechanism 3 and capable of mixing the samples with the reagents on the detection cards; the analyzing mechanisms 5 are arranged in the housing 1 and capable of analyzing the samples through detection rays; the sample discharging mechanism 6 is arranged in the housing 1 and used for removing the detection cards from the rotating mechanism 3; the sample discharging box 7 is slidably arranged at the sample discharging port and is used for containing the detection cards after completing detection; and the sample discharging mechanism 6 is capable of introducing the detection cards into the sample discharging box 7.

In the present invention, the sample feeding mechanism 2, the rotating mechanism 3, the pipetting mechanism 4, the analyzing mechanisms 5 and the sample discharging mechanism 6 are arranged in a matching manner to inspect and analyze the plurality of samples automatically, simply and efficiently, thereby saving manpower and material resources, and making inspection processes safer and inspection structures more reliable.

In the present embodiment, the pipetting mechanism 4 and the analyzing mechanisms 5 are respectively located on an upper side and a lower side of the rotating mechanism 3 and are arranged opposite to each other. Pipetting operation and operation of the analyzing mechanisms 5 can be performed synchronously or asynchronously, wherein each analyzing mechanism 5 comprises a detection module capable of emitting detection rays and an analysis module capable of analyzing the detection rays; the analysis module analyzes the detection rays penetrating the samples to obtain detection results of the samples; and the samples in the detection cards on the rotating mechanism 3 can pass between the detection module and the analysis module when the rotating mechanism 3 rotates. Specifically, the analyzing mechanisms 5 are general settings; and the structures and principles of the analyzing mechanisms will not be repeated here.

Specifically, a plurality of analyzing mechanisms 5 are provided; each analyzing mechanism 5 can be adopted to detect one detection card; and the plurality of analyzing mechanisms 5 can analyze different components in the samples through different detection rays. In the present embodiment, four analyzing mechanisms 5 are specifically provided.

Specifically, a control mechanism is arranged in the housing 1 for controlling the sample feeding mechanism 2, the pipetting mechanism 4, the analyzing mechanisms 5 and the sample discharging mechanism 6 to cooperate for completing the inspection of the samples automatically. The control mechanism is a general setting in the field; and the specific structure and working principle of the control mechanism will not be repeated here.

Optionally, the sample feeding mechanism 2 comprises a sample feeding slide rail 21, a sample feeding support base 22 and a sample feeding drive device 23, wherein the sample feeding slide rail 21 is arranged in the housing 1 and extends along a radial direction of the rotating mechanism 3; the sample feeding support base 22 is slidably arranged on the sample feeding slide rail 21; the detection cards can be placed on the sample feeding support base 22; and the sample feeding drive device 23 is arranged in the housing 1 and capable of driving the sample feeding support base 22 to slide along the sample feeding slide rail 21.

Specifically, the sample feeding drive device 23 comprises a first motor and a first transmission belt driven by the first motor, wherein the sample feeding support base 22 is connected to the first transmission belt; and the first motor is controlled by a control mechanism to start and stop as well as rotate forward and backward.

More specifically, the sample feeding mechanism 2 further comprises a sample feeding detection device 24, which is arranged in the housing 1, located at one side of the sample feeding slide rail 21 and used for detecting whether the detection cards are placed on the sample feeding support base 22. In the present embodiment, the sample feeding detection device 24 is a photoelectric sensor and is connected to the control mechanism. When the sample feeding support base 22 is retracted from the sample feeding port, if the detection cards are placed on the sample feeding support base 22, the detection cards can trigger the sample feeding detection device 24. After the sample feeding detection device 24 is triggered, the control mechanism controls the first motor to start, the first transmission belt rotates to drive the sample feeding support base 22 to slide toward the rotating mechanism 3, and the detection cards are clamped on the rotating mechanism 3. If the detection cards are not clamped on the rotating mechanism 3, the detection cards on the sample feeding support base 22 will trigger the sample feeding detection device 24 again when the sample feeding support base 22 is reset to the inside of the sample feeding port, and the control mechanism will control the sample feeding drive mechanism to clamp again at the moment.

Optionally, the rotating mechanism 3 comprises a rotating disk 31 and a rotating drive device 32, wherein the rotating disk 31 is rotationally arranged in the housing 1; a plurality of clamping positions are uniformly distributed in a circumferential direction of the rotating disk 31; one detection card can be clamped at each clamping position; and the rotating drive device 32 is arranged in the housing 1 and capable of driving the rotating disk 31 to rotate.

Specifically, the rotating drive device 32 comprises a second motor and a second transmission belt driven by the second motor, wherein the second transmission belt is wound on the rotating disk 31 and capable of driving the rotating disk 31 to rotate around the own axis.

More specifically, the second motor is controlled by the control mechanism to start and stop, so that the second motor can be better connected and matched with the sample feeding mechanism 2.

More specifically, clamping slots 311 are formed in the clamping positions; clamping protrusions are arranged on the detection cards; the clamping protrusions can be clamped into the clamping slots 311 while being pushed by the sample feeding mechanism 2; and the sample feeding mechanism 2 cannot drive the clamping protrusions to release from the clamping slots 311.

More specifically, a pressing block is arranged on the rotating disk 31; flanges are arranged in the circumferential direction of the top of each detection card; and the flange can be clamped between the pressing block and the rotating disk 31.

Optionally, the pipetting mechanism 4 comprises a pipetting fix base 41, a pipetting slide base 42, a pipetting head 43, a first pipetting drive device 44 and a second pipetting drive device 45, wherein the pipetting fix base 41 is arranged in the housing 1; the pipetting slide base 42 is slidably arranged on the pipetting fix base 41; a sliding direction of the pipetting slide base 42 is perpendicular to a rotating axial direction of the rotating disk 31; the pipetting head 43 is slidably arranged on the pipetting slide base 42 and used for transferring reagents on the detection cards; the sliding direction of the pipetting head 43 is parallel to the rotating axial direction of the rotating disk 31; the first pipetting drive device 44 is arranged on the pipetting fix base 41 and capable of driving the pipetting slide base 42 to slide; and the second pipetting drive device 45 is arranged on the pipetting slide base 42 and capable of driving the pipetting head 43 to slide.

Specifically, the pipetting slide base 42 is slidably arranged on the slide rail of the pipetting fix base 41; the pipetting head 43 slides along the radial direction of the rotating disk 31; the first pipetting drive device 44 comprises a third motor and a third transmission belt driven by the third motor, the pipetting slide base 42 is connected to the third transmission belt and is driven to slide by the third transmission belt; the second pipetting drive device 45 comprises a fourth motor, a fourth transmission belt driven by the fourth motor, a screw rod driven by the fourth transmission belt and a nut screwed to the screw rod; the pipetting head 43 is connected to the nut and capable of moving along the axial direction of the screw rod along with the nut; the pipetting head 43 is an injector driven by the fifth motor in cooperation with the screw rod and can automatically transfer the reagents.

More specifically, the third motor, the fourth motor and the fifth motor are all controlled by the control mechanism, so that reagents can be transferred more accurately.

Specifically, the pipetting mechanism 4 further comprises a pipetting support base 46, which is arranged in the housing 1 and is used for supporting the rotating mechanism 3 at the pipetting position.

In the present embodiment, the pipetting support base 46 is arranged at one side of the rotating disk 31 and is arranged around a clamping position in cooperation with the pipetting mechanism 4, so that the detection card at the clamping position is more stable and not easy to deflect during pipetting.

Specifically, the pipetting support base 46 comprises a base body fixedly arranged in the housing 1, rollers rotatably arranged on the base body, and an upper pressing plate fixedly arranged on the base body, the rollers support the rotating disk 31 from the lower side; and the upper pressing plate abuts against the rotating disk 31 from the upper side.

Optionally, the sample discharging mechanism 6 comprises a sample discharging slide rail 61, a sample discharging support base 62 and a sample discharging drive device 63, wherein the sample discharging slide rail 61 is arranged in the housing 1; the sample discharging support base 62 is slidably arranged on the sample discharging slide rail 61; the sample discharging drive device 63 is arranged in the housing 1, capable of driving the sample discharging support base 62 to slide along the sample discharging slide rail 61, and capable of removing the detection cards from the rotating mechanism 3 and pushing the detection cards into the sample discharging box 7 when the sample discharging support base 62 slides.

Specifically, the sample discharging drive device 63 comprises a sixth motor and a sixth transmission belt driven by the sixth motor, and the sample discharging support base 62 is connected to the sixth transmission belt and is driven to slide by the sixth transmission belt. The sixth motor is controlled by the control mechanism.

More specifically, the sample discharging box 7 comprises a box body 71, a pushing device 72 and a sample discharging detection device 73, wherein the box body 71 is used for containing the detection cards after completing detection, slidably arranged at the sample discharging port and provided with an introducing port 711; the sample discharging mechanism 6 is capable of introducing the detection cards into the box body 71 through the introducing port 711; the pushing device 72 is arranged in the housing 1 and used for pushing the detection cards in the box body 71 to move towards a detection end of the box body 71; and the sample discharging detection device 73 is arranged in the housing 1 and can be triggered when the detection cards in the box body 71 abut against the detection end.

In the present embodiment, the pushing device 72 comprises a seventh motor, a screw rod driven by the seventh motor, a nut screwed to the screw rod and a pushing plate connected to the nut, wherein the pushing plate is connected to a guide post; the guide post is arranged in a guide hole in a penetrating manner, and the detection cards in the box body 71 can be pushed when the pushing plate moves along axial direction of the guide post. The seventh motor is controlled by the control mechanism.

In the present embodiment, the sample discharging detection device 73 is a photoelectric sensor and is connected to the control mechanism; a ray penetrating entrance is formed in the detection end of the box body 71; the sample discharging detection device 73 can be triggered when the detection cards block the ray penetrating entrance; and the control mechanism controls a corresponding alarm prompt device to remind an operator to pull out the box body 71 full of detection cards for cleaning when the sample discharging detection device 73 is triggered.

Optionally, a sealing door is rotationally arranged at the sample feeding port; the sample feeding mechanism 2 can push the sealing door to open when feeding the samples; and the sealing door can seal the sample feeding port after finishing feeding the samples.

Specifically, the sealing door 11 is L-shaped, matched with the L-shaped sample feeding port and rotationally arranged at the sample feeding port through a reset spring, so as to ensure sealing of the housing 1.

Optionally, an analysis display screen 12 and an acrylic perspective plate 13 are also arranged on the housing 1, wherein the analysis display screen 12 is connected to the control mechanism. The operator can see the analysis structure of the detection cards through the analysis display screen 12 and can observe the operation of each mechanism in the housing 1 through the acrylic perspective plate 13.

Specifically, a switch button or knob, a code scanning port for scanning information on the detection cards, an operation status indicator lamp, a power supply interface and a USB information interface are further arranged on the housing 1.

The biochemical analyzer in the present application improves the detection sensitivity, increases the product stability, shortens the detection time, simplifies the operation process and saves the labor cost, so that the accuracy, sensitivity, rapidity, repeatability and the like of the product are obviously improved in comparison with the prior art, and the biochemical analyzer plays an important role in technical development, product development, clinical application and market expansion.

In addition, the platform technology can be extended and applied to the early diagnosis of major diseases such as microbial inflammatory infection, cardiovascular and cerebrovascular diseases, respiratory system diseases and the like based on immunoturbidimetry and enzymatic kinetics, thereby completing the breakthrough of technical bottleneck in the field of in vitro diagnosis, having great development prospects and playing a revolutionary role in promoting the progress of the early diagnosis, monitoring and guiding treatment of major diseases such as AIDS, tuberculosis and hepatitis combined with the IFD. The smooth implementation of the project will produce significant economic and social benefits.

Apparently, the above embodiments of the present invention are merely examples for illustrating the present invention, rather than limiting the embodiments of the present invention. Those ordinary skilled in the art can make other different forms of changes or variations based on the description above. It is neither necessary nor possible to enumerate all embodiments here. All modifications, equivalent replacements and improvements made within the spirit and principles of the present invention shall be included within the protection scope of claims of the present invention.

We claim:

1. A biochemical analyzer, comprising:
a housing (1), in which a sample feeding port and a sample discharging port are formed;
a sample feeding mechanism (2), which is arranged in the housing (1) and capable of introducing detection cards containing samples and reagents into the housing (1) from the sample feeding port;
a rotating mechanism (3), which is arranged in the housing (1) and capable of clamping a plurality of detection cards and driving the detection cards to rotate, wherein the sample feeding mechanism (2) can clamp the detection cards on the rotating mechanism (3);
a pipetting mechanism (4), which is arranged in the housing (1), located above the rotating mechanism (3) and capable of mixing the samples with reagents on the detection cards;
analyzing mechanisms (5), which are arranged in the housing (1) and capable of analyzing the samples through detection rays;
a sample discharging mechanism (6), which is arranged in the housing (1) and used for removing the detection cards from the rotating mechanism (3); and
a sample discharging box (7), which is slidably arranged at the sample discharging port and used for containing the detection cards after completing detection, wherein the sample discharging mechanism (6) is capable of introducing the detection cards into the sample discharging box (7).

2. The biochemical analyzer according to claim 1, wherein the sample feeding mechanism (2) comprises:
a sample feeding slide rail (21), which is arranged in the housing (1);
a sample feeding support base (22), which is slidably arranged on the sample feeding slide rail (21) and on which the detection cards can be placed; and
a sample feeding driving device (23), which is arranged in the housing (1) and capable of driving the sample feeding support base (22) to slide along the sample feeding slide rail (21).

3. The biochemical analyzer according to claim 2, wherein the sample feeding mechanism (2) further comprises a sample feeding detection device (24), which is arranged in the housing (1), located at one side of the sample feeding slide rail (21) and is used for detecting whether the detection cards are placed on the sample feeding support base (22).

4. The biochemical analyzer according to claim 1, wherein the rotating mechanism (3) comprises:
a rotating disk (31), which is rotatably arranged in the housing (1), wherein a plurality of clamping positions are uniformly distributed in a circumferential direction of the rotating disk (31), and one detection card can be clamped at each clamping position; and
a rotation driving device (32), which is arranged in the housing (1) and capable of driving the rotating disk (31) to rotate.

5. The biochemical analyzer according to claim 4, wherein clamping slots (311) are formed in the clamping positions; clamping protrusions are arranged on the detection cards; the clamping protrusions can be clamped into the clamping slots (311) while being pushed by the sample feeding mechanism (2); and the sample feeding mechanism (2) cannot drive the clamping protrusions to release from the clamping slots (311).

6. The biochemical analyzer according to claim 1, wherein the pipetting mechanism (4) comprises:
a pipetting fix base (41), which is arranged in the housing (1);
a pipetting slide base (42), which is slidably arranged on the pipetting fix base (41), wherein a sliding direction of the pipetting slide base (42) is perpendicular to a rotating axial direction of the rotating mechanism (3);
a pipetting head (43), which is slidably arranged on the pipetting slide base (42) and used for transferring reagents on the detection cards, wherein the sliding direction of the pipetting head (43) is parallel to the rotating axial direction of the rotating mechanism (3);
a first pipetting drive device (44), which is arranged on the pipetting fix base (41) and capable of driving the pipetting slide base (42) to slide; and
a second pipetting drive device (45), which is arranged on the pipetting slide base (42) and capable of driving the pipetting head (43) to slide.

7. The biochemical analyzer according to claim 6, wherein the pipetting mechanism (4) further comprises a pipetting support base (46), which is arranged in the housing (1) and used for supporting the rotating mechanism (3) at a pipetting position.

8. The biochemical analyzer according to claim 1, wherein the sample discharging mechanism (6) comprises:
a sample discharging slide rail (61), which is arranged in the housing (1);
a sample discharging support base (62), which is slidably arranged on the sample discharging slide rail (61);
a sample discharging drive device (63), which is arranged in the housing (1). capable of driving the sample discharging support base (62) to slide along the sample discharging slide rail (61) and capable of removing the detection cards from the rotating mechanism (3) and pushing the detection cards into the sample discharging box (7) when the sample discharging support base (62) slides.

9. The biochemical analyzer according to claim 1, wherein the sample discharging box (7) comprises:
a box body (71), which is used for containing the detection cards after completing detection, slidably arranged at the sample discharging port and provided with an introducing port (711), wherein the sample discharging mechanism (6) is capable of introducing the detection cards into the box body (71) through the introducing port (711);
a pushing device (72), which is arranged in the housing (1) and used for pushing the detection cards in the box body (71) to move towards a detection end of the box body (71); and
a sample discharging detection device (73), which is arranged in the housing (1) and can be triggered when the detection cards in the box body (71) abut against the detection end.

10. The biochemical analyzer according to claim 1, wherein a sealing door (11) is rotationally arranged at the sample feeding port; the sample feeding mechanism (2) can push the sealing door (11) to open when feeding the samples, and the sealing door (11) can seal the sample feeding port after finishing feeding the samples.
